(19) United States
(12) Patent Application Publication
(10) Pub. No.: US 2019/0243856 A1
(43) Pub. Date: Aug. 8, 2019

(54) COMPUTER-IMPLEMENTED METHOD OF PROCESSING DATA IN A HIERARCHAL DATA STRUCTURE AND DATA PROCESSING DEVICE OR SYSTEM FOR THE SAME

(71) Applicant: KONSOLIDATOR A/S, Søborg (DK)

(72) Inventors: Lars Højer PAASKE, Greve (DK); Jack SKOV, Espergærde (DK); Claus Finderup GROVE, Nærum (DK)

(21) Appl. No.: 16/317,108

(22) PCT Filed: Jul. 10, 2017
(86) PCT No.: PCT/EP2017/067253

§ 371 Date: Jan. 11, 2019

(30) Foreign Application Priority Data
Jul. 14, 2016 (DK) PA201670522

(51) Int. Cl. G06F 16/901

(52) U.S. Cl. CPC G06F 16/9027

(57) ABSTRACT

Computer-implemented method and system for processing data in a hierarchical data structure. The method includes obtaining data hierarchically organized according to predetermined rules, the data structure representing or having nodes and connections therebetween. Each node is associated with two or more data values each being of a respective data type, and the nodes are organized according to levels. Step I includes selecting a lowest level currently unprocessed node being connected by a respective connection to a lower-level node, the lower-level node having no connections to further lower level nodes. Step II includes performing data processing of the data value(s) of the selected lowest level currently unprocessed node and the lower-level node connected to the selected lowest level currently unprocessed node. Step III includes designating the selected lowest level currently unprocessed node as processed after the data processing has been performed. Efficient processing of data represented in/organized according to a hierarchical data structure. Advantageously all parent nodes will be traversed and processed (including processing of leafs if any).

### FIELD OF THE INVENTION

The present invention relates generally to a computer-implemented method of processing data in a data structure. Additionally, the present invention relates generally to an electronic data processing device or system implementing the computer-implemented method.

### BACKGROUND

Various data processing schemes, methods, systems, etc. (forth only referred to as data processing) exist directed at carrying out various types of data processing, calculations, etc. for various purposes where the specifics of the data processing, etc. typically will depend on the type and/or values of data to be processed and/or what the purpose is.

Certain classes or types of data processing involves data where the data processing of some (first) data is dependent on data processing of other (second) data having been carried out beforehand, i.e.—for a given particular purpose or use—the second data needs to be processed before the first data accurately can be processed. This may e.g. be the case when the result of processing the second data is to be used in or otherwise influence the processing of the first data.

One example of such data is e.g. a plurality of sensors, each sensor obtaining sensor data of a fluid where the sensors are located up-stream (or down-stream) in relation to each other and where data processing of data from a (first) sensor depends on the result of data processing of data from a (second) sensor.

Another example of such data is e.g. a plurality of heat sensors (indoor and/or outdoor sensors) measuring heat and transmitting heat values and/or data processed heat values such as current heat or current heat values at different times for a predetermined time interval, min/max heat for the predetermined interval, average heat for the predetermined interval, etc., to a master unit or controller that carries out further data processing on the received information where the data processing by the master unit or controller is dependent on data processing for the sensor data having been carried out beforehand. The master unit or controller may e.g. control a number of heating and/or air conditioning devices according to the processed data e.g. to provide a steady ambient temperature and e.g. taking further parameters such as number of people present, forecasts, etc. into account.

Other examples of such type of data where the data processing of some (first) data is dependent on data processing of other (second) data having been carried out beforehand is mentioned elsewhere in the present specification.

For such classes or types of data processing, it would be useful to have an efficient and reliable computer-implemented data processing method (and system or device for carrying out the computer-implemented data processing method).

It would also be a benefit to have a computer-implemented data processing method (and corresponding system or device) that, at least in some embodiments, reduces and/or optimises memory and/or storage requirements when executing the data processing method.

### SUMMARY

It is an object to provide an efficient and reliable computer-implemented data processing method of data where data processing of some part of the data is dependent on data processing of some other part of the data having been carried out.

Additionally, an objective is to provide a computer-implemented data processing method that, at least in some embodiments, reduces and/or optimises memory and/or storage requirements when executing the data processing method.

An aspect of the invention is defined in claim 1.

Accordingly, in one aspect, one or more of these objects is/are achieved at least to an extent by a computer-implemented method of processing data in a hierarchical data structure, the method comprising the steps of:
obtaining data organised according to a hierarchical data structure according to one or more predetermined rules, the hierarchical data structure representing or comprising a plurality of nodes and a number of connections between the nodes, wherein
   each node is associated with at least two or more data values each being of a respective data type selected from one or more data types, and
   the nodes are organised in the hierarchical data structure according to a number of levels with one node being at a first level and the other nodes being at respective lower levels,
I. selecting a lowest level currently un-processed node being connected by a respective connection to at least one lower level node, each of the at least one lower level node having no connections to further lower level nodes (i.e. being a ‘leaf’),
II. performing data processing of one or more of the data values of the selected lowest level currently un-processed node and the at least one lower level node connected to the selected lowest level currently un-processed node and associating a result of the data processing with one or more data values of the selected lowest level currently un-processed node, and
III. designating the selected lowest level currently un-processed node as processed after the data processing has been performed.

In other words, step I selects (in case of equally applicable candidates one is chosen according to a predetermined criteria) a currently un-processed lowest level parent node—also denoted LLUP for short throughout the present specification—having only one or more leafs (and no parents) as children; step II executes data processing for the data values of the LLUP and its one or more children and associates (e.g. stores) a result of the data processing with currently un-processed node after which, step III designates the LLUP as being processed.

In this way, efficient processing is provided or enabled of data that is or may be represented in and/or organised according to a hierarchical data structure, such as a tree data structure or other suitable hierarchical data structure. In effect, some or all parent nodes may be traversed and processed (including processing of leafs if any) by repeating the steps one or more times.

This is particularly useful where the processing of one or more data values of a particular parent node needs to be influenced by processing and/or the values or content of one or more children nodes, descendants, or lower level nodes of that particular parent node. Examples of data processing having such properties are disclosed herein (above and in the following).

It should be noted that by the term ‘lowest’ in relation to lowest level node, it is the lowest in the sense that the (currently un-processed) node is furthest away—e.g. as counted by number of connections or number of nodes or some other suitable measure—from a topmost node of the hierarchical data structure, often also referred to as primary or root node. It is stressed that the lowest level currently un-processed node is not always, and often will not be, a lowest level node (or a node furthest away from the topmost node) but rather a second most lowest or second furthest away node as it may, and often will be, connected to one or more nodes that each is not connected to any further lower nodes, i.e. connected to one or more ‘leafs’.

A node directly connected to a higher level node is often designated as a child (of the higher level node) while the higher level node often is designated as a parent (of the connected lower level node). A node can both be a child and a parent but to different nodes. A node without any children is often referred to as leaf or the like. A (first) node may be referred to as a descendant, etc. of another (second) node if the first node is connected (via one or more levels) to the second node and the first node is at a lower level than the second node. Accordingly, a (first) node may be referred to as an ancestor, etc. to another (second) node if the second node is a descendant, etc. of the first node. Two nodes that each have a connection to one parent node may be referred to as siblings. Such hierarchical data structures are also often referred to as a (data) tree structure and are generally known.

A given node (including all its descendants) may be regarded as a sub-tree structure, sub-part structure, sub hierarchical data structure, etc. of the overall structure.

In some embodiments, the method comprises repeating steps I, II, and III until a desired number of nodes, e.g. some or all, have been processed or least involved in the data processing where relevant.

In some embodiments, the method comprises repeating steps I, II, and III until a desired number of nodes, e.g. some or all, have been processed, wherein

step I after a first execution comprises:
selecting a lowest level currently un-processed node being connected by a respective connection to at least one lower level node and/or one or more already processed nodes, each of the at least one lower level node, if any, having no connections to further lower level nodes, and
   step II after a first execution comprises:
performing data processing of one or more of the data values of the selected lowest level currently un-processed node, the at least one lower level node, and/or the one or more already processed nodes (using the associated result(s) associated with it when being processed at earlier iterations) connected to the selected lowest level currently un-processed node and associating a result of the data processing with one or more data values of the selected lowest level currently un-processed node.

In some embodiments,
one node is designated as a primary or root node,
the hierarchical data structure comprises or represent one primary node connected to at least another node by a connection, and
at least one of the nodes is a parent node of at least one other node and at least one of the nodes is a child node of at least one of the nodes.

In some embodiments, the hierarchical data structure is tree data structure. Preferably, the tree data structure is not a binary tree structure, i.e. a parent node can have more than two children.

In some embodiments, the computer-implemented method further comprises the step of organising received or provided data according to the hierarchical data structure based on the one or more predetermined rules.

In some embodiments, the one or more predetermined rules specify that
any two given nodes in the hierarchical data structure are connected if data processing of data values of one of the two nodes is dependent on data values, and/or data processing thereof, of the other of the two nodes, where the node for which data processing of data values is dependent is arranged at an adjacent higher level (i.e. a level one step or distance closer to the root or primary node) than the node that the data processing of data values is dependent upon,
any given node associated with data values for which data processing is not dependent on data values, and/or data processing thereof, of one or more other nodes will
   be connected to a higher level node in the hierarchical data structure when data processing of the data values of the higher level node is dependent on data processing of the data values of the any given node, and
   have no connection to any lower level nodes (i.e. it will be a ‘leaf’),
one given node associated with data values for which data processing is dependent on data values, and/or data processing thereof, of one or more other nodes but where no other node is associated with data values for which data processing is dependent on data values, and/or data processing thereof, of the one given node is designated as a primary node.

In some embodiments,
the hierarchical data structure comprises a particular node that is connected to at least two nodes each at an adjacent higher level than a level of the particular node (i.e. the particular node is connected to at least two parents) and each of the at least two nodes being associated with a data value representing a weight of the connection to the particular node, and
   wherein the method further comprises the step of
replacing the connections between the particular node and the connected at least two nodes with one connection for each of the at least two nodes with a copy of the particular node including any lower level nodes being connected to the particular node and applying the respective weight to the (relevant, i.e. at least some of the) data values of the particular node and data values of any lower level nodes being connected to the particular node for each copy of the particular node.

In effect, the substructure of the particular node including the particular node itself is duplicated or copied a number of times equal to the number of its parents where a relevant weight (that may be different for each substructure or copy) is applied as appropriate to relevant data values where each parent will be connected to one of the appropriate substructures. One example of this operation is e.g. given in connection with FIG. 6b and related description.

This enables the data processing of the computer-implemented method and embodiments thereof to be able to readily handle hierarchical data structures comprising cyclical connections (as such nodes are converted to non-cyclical connections), which would otherwise cause complications or added complexity when traversing the hierarchical data structures and carrying out the data processing. Hierarchical data structures comprising cyclical connections is often also referred to as ‘many (children) to many (parents)’ data structures while hierarchical data structures not comprising cyclical connections often is referred to as ‘many (children) to one (parent)’.

In some embodiments, the step of performing data processing of one or more of the data values of the selected lowest level currently un-processed node and the at least one lower level node connected to the selected lowest level currently un-processed node comprises performing predetermined data processing of data values of the selected lowest level currently un-processed node and data values of the at least one lower level node connected to the selected lowest level currently un-processed node providing a processing result comprising one or more data values. Alternatively, in some other embodiments, the step of performing data processing of one or more of the data values of the selected lowest level currently un-processed node, the at least one lower level node and/or one or more already processed nodes connected to the selected lowest level currently un-processed node comprises performing predetermined data processing of data values of the selected lowest level currently un-processed node and data values of the at least one lower level node and/or one or more already processed nodes connected to the selected lowest level currently un-processed node providing a processing result comprising one or more data values.

In some further embodiments, the method further comprises associating the processing result with the selected lowest level currently un-processed node. In this way, intermediate results or results for specific nodes (i.e. what they represent) will readily be available for storage and/or presentation.

In some embodiments, the method further comprises replacing the data values the selected lowest level currently un-processed node with the processing result and deleting or removing the at least one lower level node connected to the selected lowest level currently un-processed node from the hierarchical data structure. This reduces the hierarchal data structure (and thereby the memory and/or storage requirements for it) as data processing progresses.

In some embodiments, the hierarchical data structure comprises
data values for each node being associated with a first state or a first time, and
data values for each node being associated with a second state or a second time, where the first state or first time respectively is earlier than the second state or the second time,
   wherein step II comprises
a) deriving, for each of the at least one node of the selected lowest level currently un-processed node, the at least one lower level node, and/or the one or more already processed nodes connected to the selected lowest level currently un-processed node, a difference between (or alternatively applying a different function or processing step) a data value being associated with the first state or first time and the data value being associated with the second state or second time resulting in a differential result value.

It is noted, that in some further embodiments, additional processing may be carried out and/or a plurality of differential result values may be derived. As an example a sum may e.g. be derived for a number of differential result values.

Alternatively, step II comprises
b) deriving, for each of the at least one node of the selected lowest level currently un-processed node, the at least one lower level node, and/or the one or more already processed nodes connected to the selected lowest level currently un-processed node, a difference between (or alternatively applying a different function or processing) a first data value and a second data value, both data values being associated with the first state or first time, resulting in a first differential (or other) value and a difference between (or alternatively applying a different function or processing) a third data value and a fourth data value, both data values being associated with the second state or second time, resulting in a second differential (or other) value, and deriving a difference (or alternatively applying a different function or processing) between the first and the second differential value resulting in a differential (or other) result value.

It is noted, that in some further embodiments, additional processing may be carried out and/or a plurality of differential result values may be derived. As an example a sum may e.g. be derived for a number of differential result values.

The different states/times may e.g. represent data values (for a same or corresponding hierarchical data structure) at different times.

The bottom up approach according to the present invention is particularly suited for handling parameters that (potentially) change over time or between states.

In some embodiments, the data values associated with the first state/first time may e.g. be sensor values and associated values that change over time/between states (e.g. cost pr. kWh, etc.) obtained at a specific time and date while the data values associated with the second state/second time may be sensor values obtained at a later specific time and date. In other embodiments, the data values associated with the first state/first time may e.g. be values, such as turn-over/revenue, costs, income, profit, percentage of ownership, etc. for one particular month, quarter, year, etc. while the data values associated with the second state/second time may the same (i.e. then often with different values) for a later or subsequent particular month, quarter, year, etc.

As an alternative, instead of one hierarchical data structure comprising data values being associated with the first state/first time and the second state/second time, two hierarchical data structures, one for each state/time can be used where processing then involves data values of corresponding nodes of each hierarchical data structure.

In some embodiments, more than two states/different times may be used (e.g. either as part of one hierarchical data structure or as a corresponding plurality of hierarchical data structures).

In some embodiments (and according to a further aspect of the present invention), at least one data value for each node represent a cash-flow for the legal entity that a node represents in a hierarchical data structure that represent a number of legal entities or companies inter-connected by individual (full or part) ownership with an overall group level company (being represented by the root node). In these embodiments, alternative a) above will provide the cash flow change between a first time period (e.g. Q1) and a second time period (e.g. Q2). The bottom up approach according to the present invention will ensure that a reliable cash-flow measure accurately and efficiently can be derived for the group level company even taking potential part ownerships (e.g. as governed by the weight as disclosed herein), different working currencies (that potentially change or fluctuate in value compared to other currencies over time), etc. into account. In effect, the cash-flow measure of the group level company can be derived reliably and very accurately using the individual cash-flows of the companies that the group level company has full or part and direct or indirect ownership over and e.g. handling varying exchange rates appropriately.

As an alternative to having a data value for each node directly representing the cash-flow, the respective cash-flow for the nodes could be derived from data values (e.g. from financial key figures) having an effect on the cash-flow. For each of these, a difference (a differential result value) could be derived indicating the changed between the respective states or times and deriving a sum resulting in a representation of the cash-flow. In this context, some of the key figures will have a positive impact on the cash-flow while others will have a negative impact, as is generally known.

In some embodiments, the hierarchical data structure is associated with a first overall data type for a number of data values of the plurality of nodes, and wherein the method further comprises converting (by applying an appropriate multiplier or even a more complex formula), if needed according to a predetermined criteria, the differential result value into a data value of the first overall data type.

In some embodiments, the first overall data type represents a particular currency, e.g. the used or natural currency of a group level company. In such embodiments, the conversion (e.g. using an average currency for a given time period) may ensure that even legal entities having data values in another currency/other currencies will be converted into the group level company already at the processing stage (by applying an appropriate exchange rate or average exchange rate for a given time period), which greatly will increase the accuracy of the resulting—after processing—data value(s) of the group level company. The currency conversion has particular advantages in connection with calculating a cash flow for a group level company where at least one subsidiary has data values with values given in a different currency.

In some alternative embodiments, the first overall data type represents a particular temperature scale (e.g. ° C. or Fahrenheit). In such embodiments, the conversion can ensure that e.g. a master unit or controller (as represented by the root node)—working according to one temperature scale—of a number of sensors (as represented by lower level connected nodes as disclosed herein)—all or some working according to a different temperature scale—will be able to work correctly.

In yet other alternative embodiments, the first overall data type represents a cost pr. energy unit or average cost pr. energy unit for a given time period (e.g. EUR/kWh). In such embodiments, the conversion can ensure a proper handling e.g. of certain parameters (potentially) varying or fluctuating over time or between states.

According to another aspect of the present invention, a computer system or device is provided wherein the computer system or device is adapted to execute the method and embodiments thereof as disclosed herein.

According to yet another aspect of the present invention, a non-transient computer-readable medium, having stored thereon, instructions that when executed by a computer system or device cause the computer system or device to perform the method and embodiments thereof as disclosed herein.

### Definitions

All headings and sub-headings are used herein for convenience only and should not be constructed as limiting the invention in any way.

The use of any and all examples, or exemplary language provided herein, is intended merely to better illuminate the invention and does not pose a limitation on the scope of the invention unless otherwise claimed. No language in the specification should be construed as indicating any non-claimed element as essential to the practice of the invention.

This invention includes all modifications and equivalents of the subject matter recited in the claims appended hereto as permitted by applicable law.

### BRIEF DESCRIPTION OF THE DRAWINGS

FIG. 1 schematically illustrates a representation of an exemplary hierarchical data structure;

FIG. 2 schematically illustrates a representation of an exemplary hierarchical data structure corresponding to the one of FIG. 1 with a set of values indicated for each node;

FIG. 3 schematically illustrates a flow chart of an embodiment of a computer-implemented method of processing data in a hierarchical data structure;

FIG. 4 schematically illustrates a flow chart of an embodiment of a step of the flow chart of FIG. 3;

FIGS. 5a and 5b schematically illustrate an order of processing nodes of an exemplary data structure by the flow charts of FIGS. 3 and/or 4 and embodiments thereof;

FIGS. 6a and 6b schematically illustrate pre-processing of a data structure and/or the data according to some embodiments;

FIG. 7 schematically illustrates, as an example, what data values are processed at each step in the order of processing of FIG. 5a;

FIGS. 8a-8g schematically illustrate an embodiment where the hierarchical data structure is reduced as data processing progresses;

FIG. 9 schematically illustrates a number of client systems or devices communicating with a data processing device or system according to the present invention; and

FIG. 10 schematically illustrates a functional block diagram of embodiments of an electronic data processing device or system implementing various embodiments of the method mentioned throughout the specification.

### DETAILED DESCRIPTION

Various aspects and embodiments of a computer-implemented method and a computer system or device implementing the computer-implemented method as disclosed herein will now be described with reference to the figures.

When/if relative expressions such as “upper” and “lower”, “right” and “left”, “horizontal” and “vertical”, “clockwise” and “counter clockwise” or similar are used in the following terms, these typically refer to the appended figures and not necessarily to an actual situation of use. The shown figures are schematic representations for which reason the configuration of the different structures as well as their relative dimensions are intended to serve illustrative purposes only.

Some of the different components are only disclosed in relation to a single embodiment of the invention, but is meant to be included in the other embodiments without further explanation.

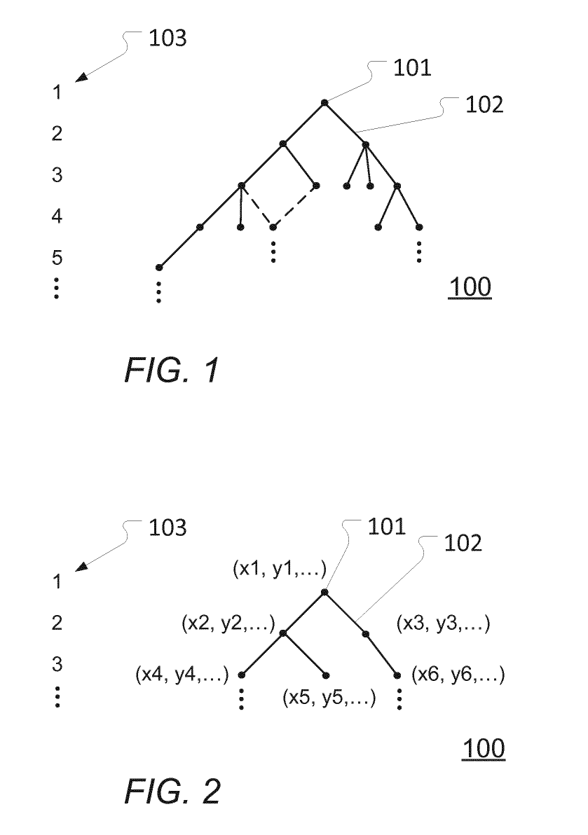

FIG. 1 schematically illustrates a representation of an exemplary hierarchical data structure.

Shown is a representation of an exemplary hierarchical data structure 100 comprising a number of nodes, vertices, (connection) points, or similar (forth referred to only or mainly as nodes) 101 and a number of connections, links, edges, or similar (forth referred to only or mainly as connections) 102, where the number of nodes, the number of connections, and/or what and how nodes are connected by the connections will depend on an actual implementation and/or the data that is being represented e.g. as disclosed herein.

Further shown is a number (here as an example 1 to 5+) of levels 103, where the number of levels also will depend on an actual implementation and/or the data that is being represented. The levels are for explanatory purposes and need not—although they for some embodiments can be—be a part of the hierarchical data structure 100 as they can be inferred or derived by the nodes and connections as generally known.

The hierarchical data structure 100 will—once representing data—comprise at least one node with (precisely) one node often being referred to or designated as root, root node, primary node, or the like.

The root node is located or organised in the hierarchical data structure (in the following equally referred to simply as data structure) at a first level often designated highest (or lowest depending on notation), beginning, earliest, etc. hierarchical level. In the shown example, the root node is the single uppermost node at level 1. According to other notations, the first level could e.g. be designated level 0. Throughout the present specification, unless expressively stated otherwise, the root level or level 1 is regarded as the highest level.

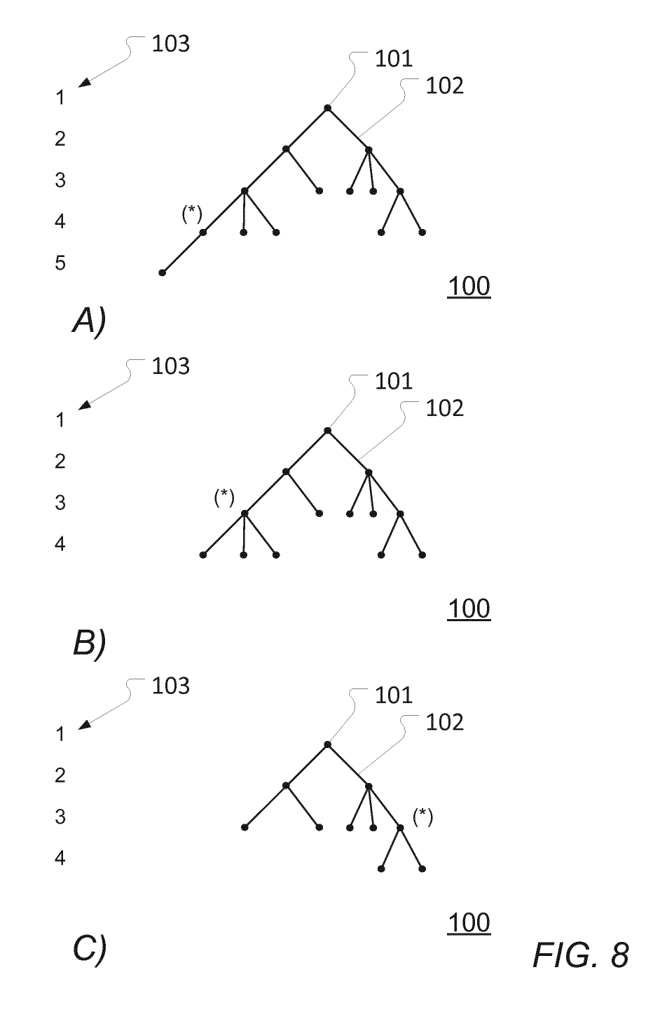

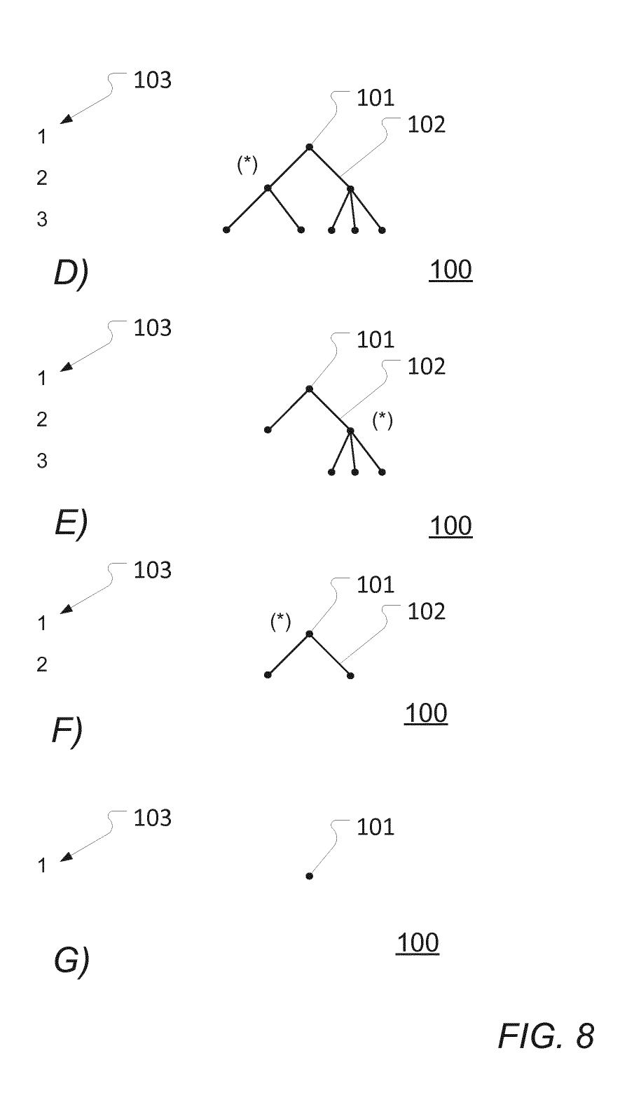

The root node is—once the data structure is representing data—connected to one or more other nodes located at a next level, e.g. a lower (or higher depending on notation), a second, etc. level, of the hierarchical level. According to this representation, the root node will be connected to nodes at the next level/level 2. In the shown example of FIG. 1, the root node is connected to two nodes at level 2. In other examples, the root node could be connected to only one node or alternatively to more than two nodes. The root node could also be connected to zero nodes as a principle but not for practical implementations or purposes unless the data structure is being built (or data processing according to some embodiments is completed as seen e.g. in FIG. 8g). A level of a node generally designates the depth of node in the data structure or equally the distance to the root node as generally known.

According to the context of the present invention, each node 101 of the hierarchical data structure 100 will have a set of data associated (or stored) with it, i.e. each node is associated with two or more data values of one or more data types where the values and data types will depend on actual use and/or implementation. This is e.g. illustrated in FIG. 2 for a simpler data structure 100.

In the shown example of FIG. 1, the root node has two children at level 2, the leftmost node at level 2 has two children at level 3 while the rightmost node at level 2 has three children at level 3, the leftmost node at level 3 has three children at level 4, the second leftmost node at level 3 has one child at level 4 while the rightmost node at level 3 has two children at level 4, and the remaining children in-between at level 3 has no children; etc.

In some embodiments, it is allowed that a given node may be a child of two (or more) different parent nodes. This is illustrated as an example in FIG. 1 by dashed lines each connecting two parent nodes to one single child (in FIG. 1 the first and the second leftmost nodes at level 3 are each connected to the same node (the third leftmost node) at level 4).

Higher/lower, left/right, etc. are only used for explanatory purposes in relation to the Figure(s).

It is to be understood that other implementations of hierarchical data structures than a tree structure may be used according to the present invention. Examples of such include database structures, network based structures, oriented graphs, or other suitable hierarchical data structures.

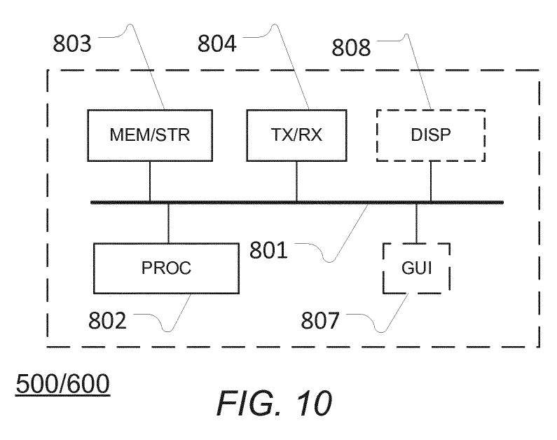

The hierarchical data structure 100 may e.g. be stored in a suitable storage format in a suitable electronic memory and/or electronic storage (see e.g. 803 in FIG. 10) or the like.

A hierarchical data structure 100 such as shown in FIG. 1—and corresponding ones—will be processed according to the present invention as explained further in the following.

FIG. 2 schematically illustrates a representation of an exemplary hierarchical data structure corresponding to the one of FIG. 1 with a set of values indicated for each node.

Shown is a hierarchical data structure 100 corresponding to the one shown in FIG. 1 (but with a different structure) comprising a number of nodes 101 connected by connections 102 in a hierarchical data structure 100 as disclosed herein. Each node 101 is associated with two or more data values of one or more predetermined data types where the values and data types will depend on actual use and/or implementation. Some of the data values may be of the same data type but more often at least some are different. The two or more data values may e.g. be arranged and/or stored as a list data structure, a matrix data structure, database entries/structures, etc., or in any other suitable way. The predetermined data types may e.g. include integers (e.g. tiny int, big int, small int, bit-values, flags, etc.), floating numbers (e.g. single or double precision, etc.), text or strings, currencies, unique identifier data type, binary/raw data, other parameters, etc., or any other suitable data type. The data values may be stored in the hierarchal data structure at the respective nodes or alternatively they may be associated with the respective nodes and stored according to another data structure.

In the shown example of FIG. 2, the hierarchical data structure 100 comprises a root node associated with data values x1, y2, . . . and having two children associated with data values x2, y2, . . . and x3, y3, . . . , respectively, where the leftmost node (the node with data values x2, y2, . . . ) has two children associated with data values x4, y4, . . . and x5, y5, . . . , respectively, and the rightmost node (the node with data values x3, y3, . . . ) has one child associated with data values x6, y6, . . . , and so on.

In some embodiments, the data type of corresponding data values will be the same, i.e. all x data values will be of the same data type, all y data values will be of the same data type, etc.

In some embodiments, two or more data values may be of the same data type, and combinations thereof, e.g. type x=type z $ type y, etc.

It is to be understood that some data values (of a predetermined data type) may be the same, e.g. x3=100; x7=100, but some data values (of a predetermined data type) may also (and often will) be different, e.g. x1=150; x2=275.

The data values may be obtained from one or more internal and/or external data sources (see e.g. 500 in FIG. 9) and formatted and/or organised into the hierarchical data structure and in some embodiments using filter, parsing, pre-conversion, pre-formatting, etc. step(s) as appropriate or preferred. This may e.g. include formatting or converting data into a same data type.

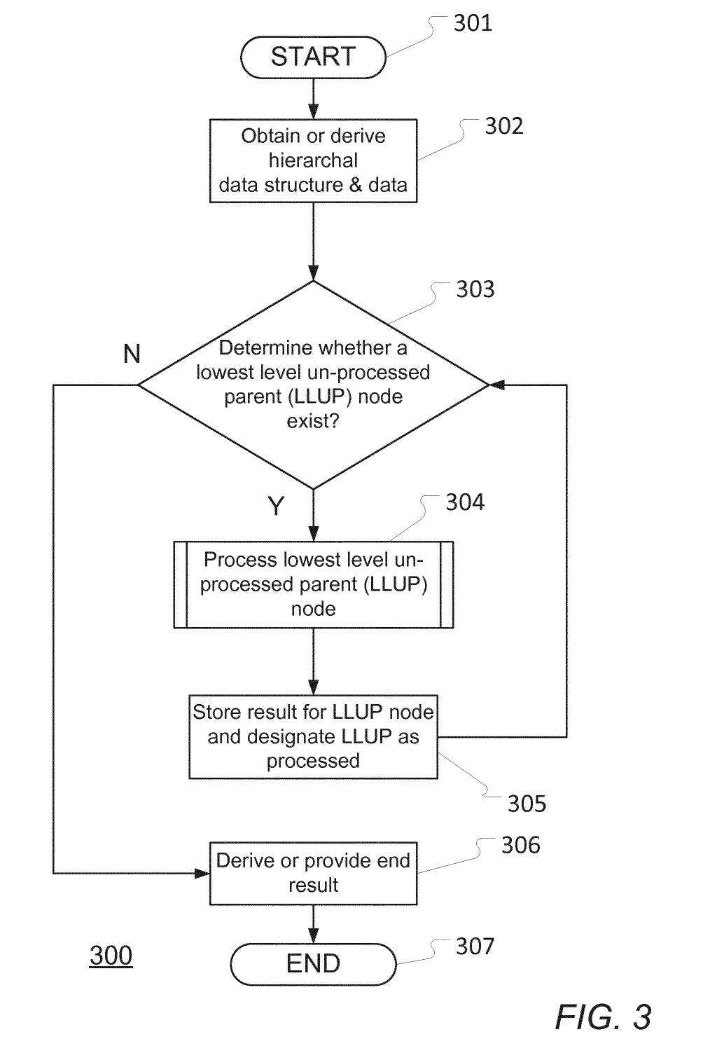

According to an aspect of the present invention, the data of the hierarchical data structure 100 is processed as disclosed herein and e.g. as explained further in connection with FIGS. 3 and/or 4 and embodiments thereof.

FIG. 3 schematically illustrates a flow chart of an embodiment of a computer-implemented method of processing data in a hierarchical data structure.

Shown in FIG. 3 is a flow chart of an embodiment of a computer-implemented method 300 of processing data in a hierarchical data structure corresponding to the ones of FIGS. 1 and 2 (but e.g. with a different structure and/or data values) where the computer-implemented method is performed by an electronic data processing device or system, e.g. such as the one illustrated in FIG. 10.

At step 301, the method starts and potentially is initialized, etc.

At step 302, a hierarchical data structure as disclosed herein (and e.g. corresponding to the ones shown and explained in connection with FIGS. 1 and 2 and embodiments thereof) is provided, derived, or obtained (forth only referred to as obtained). The obtained data structure may already contain data or alternatively the data may subsequently be provided, derived, or obtained.

As disclosed herein, each node of the data structure comprises or is or will be associated with two or more data values of one or more predetermined data types as disclosed herein.

According to some embodiments, each node may further comprise or be associated with data or parameters indicating how the data values are to be processed by the method.

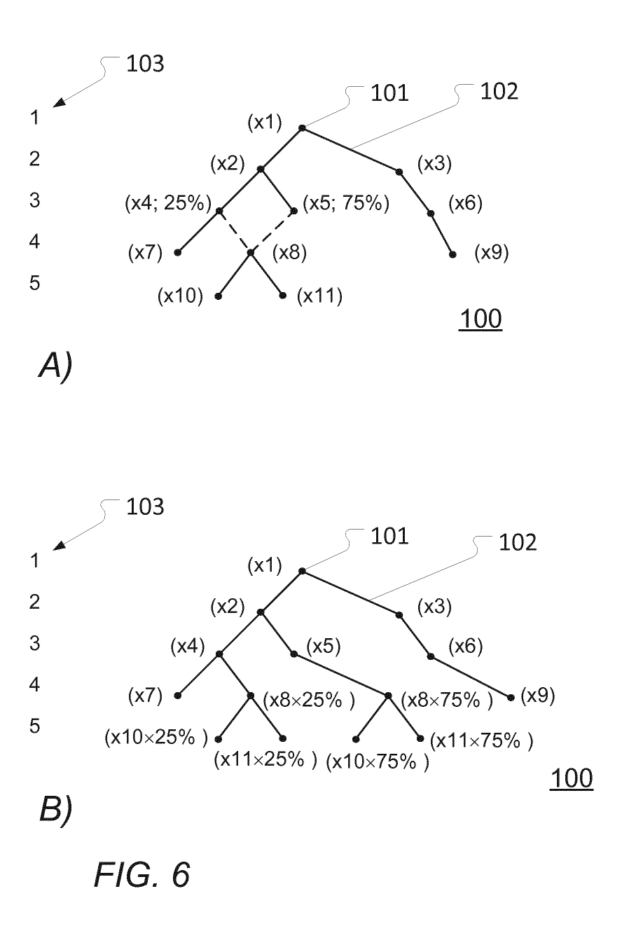

In some embodiments, step 302 (or another step) may also comprise pre-processing e.g. in the form of (re-)arranging the data structure and/or the data e.g. to facilitate enhanced processing, such as faster processing time, simpler processing/calculations, etc. One example of this is e.g. shown and explained in connection with FIGS. 6a and 6b for embodiments where at least one data value of a parent node is a weight (relating to the data values of its child/children/descendant(s)). In some embodiments, step 302 (or another step) may also pre-process data values into suitable data types (e.g. converting floating numbers into integers or the other way around, etc.).

In some embodiments, step 302 (or another step) comprises obtaining or receiving relevant data and arranging the data in the hierarchical data structure according to one or more predetermined rules. The one or more predetermined rules is, at least in some embodiments, dependent on the kind of data values and/or data processing to be carried out.

In some embodiments, the one or more predetermined rules specify that
any two given nodes in the hierarchical data structure are connected if data processing of data values of one of the two nodes is dependent on data values, and/or data processing thereof, of the other of the two nodes, where the node for which data processing of data values is dependent is arranged at an adjacent higher level than the node that the data processing of data values is dependent upon,
any given node associated with data values for which data processing is not dependent on data values, and/or data processing thereof, of one or more other nodes will
   be connected to a higher level node in the hierarchical data structure when data processing of the data values of the higher level node is dependent on data processing of the data values of the any given node, and
   have no connection to any lower level nodes,
one given node associated with data values for which data processing is dependent on data values, and/or data processing thereof, of one or more other nodes but where no other node is associated with data values for which data processing is dependent on data values, and/or data processing thereof, of the one given node is designated as a primary node.

In one example, the data represent a number of sensor values obtained from a number of sensors where data values representing sensor values is to be processed and where data processing for one or more sensor values is to be carried out before data processing for other one or more sensor values correctly can be carried out.

According to this example, each node may represent a sensor where the hierarchical data structure is derived with connections between respective nodes that reflect what nodes needs to be processed before processing other nodes, i.e. that reflect what sensor values needs to be processed before processing other sensor values. Nodes that have no dependency themselves but where other nodes are dependent on them will be leafs while one node having one or more dependencies but where no node is dependent on that particular node will be the root node. In this example, the root node may e.g. represent a master unit or controller of the sensors. Each node will, as an example, have data values associated with it that represent obtained sensor values for that particular sensor e.g. over time.

In another example, the data represent companies linked through full or part ownership, i.e. a group of companies tied together through ownership, where the data values represent numbers relating to the companies of suitable data type, such as x turn-over/revenue (e.g. floating number), y costs (e.g. floating number), z profit (e.g. floating number), currency (e.g. text), percentage of ownership (e.g. floating number), etc.

According to this example, each node may represent an individual company and have data associated with it that represent the numbers relating to given company. The root node may be a group level company (that has ownership of other companies but does not have a (company) owner itself). In such an example, the financial statement of the group level company will depend heavily on the financial statement of its subsidiaries. Connections between the nodes are made according to ownership, e.g. if company A owns at least a part of company B then a connection is made between node A and B where node A will be a parent (as it is the owner) to node B (as it is owned). Company/node A will be closer (counted in number of connections, levels, etc.) to the root node than company/node B. If company B also owns at least a part of a company C then a node C will be connected to node B as a child. A percentage of ownership related to a given connection may be stored as a data value, e.g. if company A owns 55% of company B, a connection will be made between node A and B with node A being the parent of node B and a data value associated with node A will indicate 55% in relation to node B, and so on. Other representations may also be used. Accordingly, it is e.g. enabled to provide an accurate and efficiently derived consolidated financial statement of the group level company, even for very elaborate and complex ownership structures. As disclosed herein, a reliable cash-flow measure can also accurately and efficiently be derived for the group level company even taking potential part ownerships, different working currencies (e.g. fluctuating in value over time), etc. into account.

As mentioned, other uses or examples of data will typically use other predetermined rules to arrange the data according to a hierarchical data structure.

However, regardless of what the data represent, each hierarchical data structure may be processed as described in the following and as disclosed herein.

At step 303, it is checked or tested whether a lowest level (i.e. being furthest away from the root node) parent node (i.e. specifically not a leaf node) that has not yet been processed according to the present invention exists in the hierarchical data structure or not, i.e. it is checked whether a lowest level currently un-processed node having one or more leafs and no (un-processed) parents as children is present or not. Such a parent node may for short also be denoted an LLUP node. In case of equally applicable candidates, one candidate is selected according to one or more appropriate criteria. In case of a plurality of equally applicable candidates, the currently un-selected one(s) are simply selected (and subsequently processed) at subsequent executions of step 303.

If such a lowest level un-processed parent node does not exist in the hierarchical data structure, it signifies—for practical purposes—that all nodes, including the root node, have been processed, and the method proceeds to step 306 where an end result or final result is derived or obtained. If such a lowest level un-processed parent node does exist in the hierarchical data structure, the method proceeds to step 304. Determining such a LLUP may be done by finding the LLUP having the largest distance, e.g. according to number of connections, to the root node.

At step 304, the selected lowest level (currently) un-processed parent node is processed. Since the selected node is a lowest level un-processed parent node it follows that the selected node has one or more children nodes that a) has no children nodes of their own (i.e. they are leafs) and/or b) has one or more parent nodes as children but where those parent nodes have been processed previously by earlier executions or iterations of step 303 (and subsequent steps).

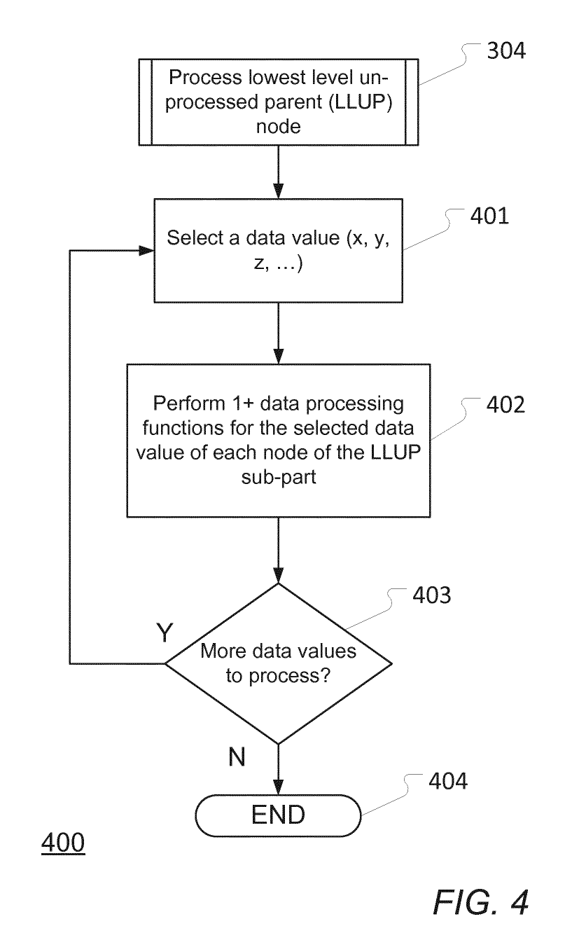

The processing being executed (and thereby the result of the processing) at step 304 will typically depend on specific use and/or implementation. Some embodiments of step 304 are shown and explained in connection with FIG. 4.

After the appropriate processing has been executed, the method proceeds to step 305 where the result of the processing is saved and/or stored as a result for that particular LLUP node.

After processing, the LLUP node is now designated as processed signifying that the whole sub-tree or sub-part of the data structure below (and including) the LLUP node, i.e. the LLUP node and its siblings, has been processed (since it is the or a lowest level un-processed node that is selected at step 303).

As a simple example, take e.g. the node at level 2 associated with values x2, y2, . . . of FIG. 2 and assuming that its children do not have any further children of their own. Processing this node, using a simple calculation or operation (here ‘+’ for both children) as a simple illustrative example would yield that the node, after processing, is associated with the data values x2+x4+x5; y2+y4+y5, . . . , where the respective data values would be the result of the processing or calculation, e.g. if x2=50, x4=75; x5=33 the x-value of the given node would, after processing, be 158 (derived by calculating 50+75+33).

The children (and, if any, their children, and so on, i.e. the sub-tree of the LLUP) is no longer relevant and in effect they may be replaced (or represented) by one node (a leaf) having the data values according to the executed processing. This is illustrated in FIGS. 8a-8g according to one exemplary embodiment. Reducing the hierarchal data structure as data processing progresses will reduce the memory and/or storage requirements of the hierarchical data structure further and further as the data processing progresses.

It should be noted, that the hierarchical data structure does not necessarily need to actually be modified according to this (i.e. replacing the LLUP by a node) but it should be designated or treated as such for these processing purposes. Keeping the original hierarchical data structure and associated data values intact will be a benefit if the data structure needs to be processed again, re-run, etc. e.g. due to updating at least one value of a node of the hierarchal data structure. In some embodiments, the hierarchical data structure could be stored in a storage in its original form (thereby being available for re-runs, etc.) while the hierarchical data structure in the memory is reduced as data processing progressed (which will save memory and potentially bandwidth, etc.).

After step 305 has been executed, the method loops back again to step 303 where a new or next LLUP will be selected (if any remains). In this way, steps 303 to 305 are repeated until there are no longer any unprocessed nodes left. The last nodes to be processed will be the root node (as LLUP) and its children. Once all nodes have been processed, step 303 will proceed to step 306 where a final end result is provided or derived. In some embodiments, the final end result is simply the data values of the root node after processing all LLUPs. In other embodiments, step 306 includes further processing to arrive at the end result. The end result may be used in an appropriate way depending on actual use and/or implementation. After step 306 has been executed, the method ends at step 307.

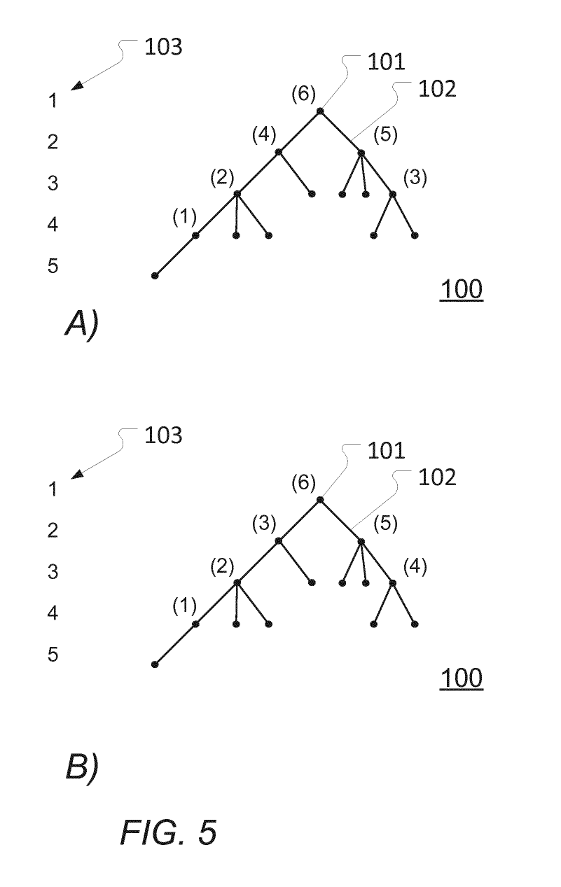

In this way, efficient processing is provided or enabled of data that is or may be represented in and/or organised according to a hierarchical data structure, such as a data tree structure. In effect all parent nodes will be traversed and processed (including processing of leafs if any). The processing order of the parent nodes will depend on how a particular data structure is organised but in common is that the nodes are processed in the order of the (current) lowest and non-processed parent nodes as shown in FIG. 5a according to one exemplary embodiment. An equally applicable alternative to this example is shown and explained in connection with FIG. 5b.

This is particularly useful where the processing of one or more data values of a particular parent node needs to be influenced by processing and/or the values or content of one or more children nodes of that particular parent node.

As will be explained in connection with FIGS. 5a and 5b, according to the present invention, the parent nodes of a hierarchical data structure may be processed in different order (within certain variations) and still obtain the same result.

The method of FIG. 3 and embodiments thereof may be used as part of other methods.

It should be noted that in some embodiments, the method may comprises one or more filter, parsing, pre-conversion, pre-formatting, etc. steps as appropriate or preferred as part of step 301 or as separate step(s) before step 302.

FIG. 4 schematically illustrates a flow chart of an embodiment of a step of the flow chart of FIG. 3.

Shown is one implementation of step 304 of FIG. 3.

At step 401, a data value to be processed is selected, e.g. one of x, y, z, etc. as illustrated in FIG. 2 is selected.

At step 402, the selected data value, e.g. the x's, of all the nodes of the sub-part or sub-tree of the selected LLUP node (as determined in step 303 of FIG. 3), i.e. the LLUP node and its siblings including leafs (and parents already being processed earlier), is processed according to one or more predetermined or selected data processing steps or calculations. The sub-part or sub-tree of the LLUP will only contain leafs (and/or parents already being processed) in addition to the LLUP node itself as the LLUP is a lowest level un-processed node.

As one simple example, the one or more predetermined or selected data processing steps or calculations is a simple ‘+’ operation. If the selected data value as an example is x, the data processing would e.g. in the exemplary hierarchical data structure of FIG. 2 yield x2+x4+x5, etc.

In some embodiments, the data processing function(s) for a particular data value of all the nodes, e.g. for all the x's, will be the same while it may be the same or different for different respective data values of the nodes, e.g. all the x's and all the y's are respectively summed (same) or all the x's are summed while all the y's are multiplied (different) as a very simple example. Alternatively, depending on use, the data processing may be mixed, e.g. x2=x4+x5 and y2=y4*y5.

In some embodiments, the data values are stored for different time instances or different states, e.g. x=>x(t). In such embodiments, the data processing may e.g. include data values of earlier time instances or other states, e.g. x2(t)=x2(t−1)+x4(t)+x5(t).

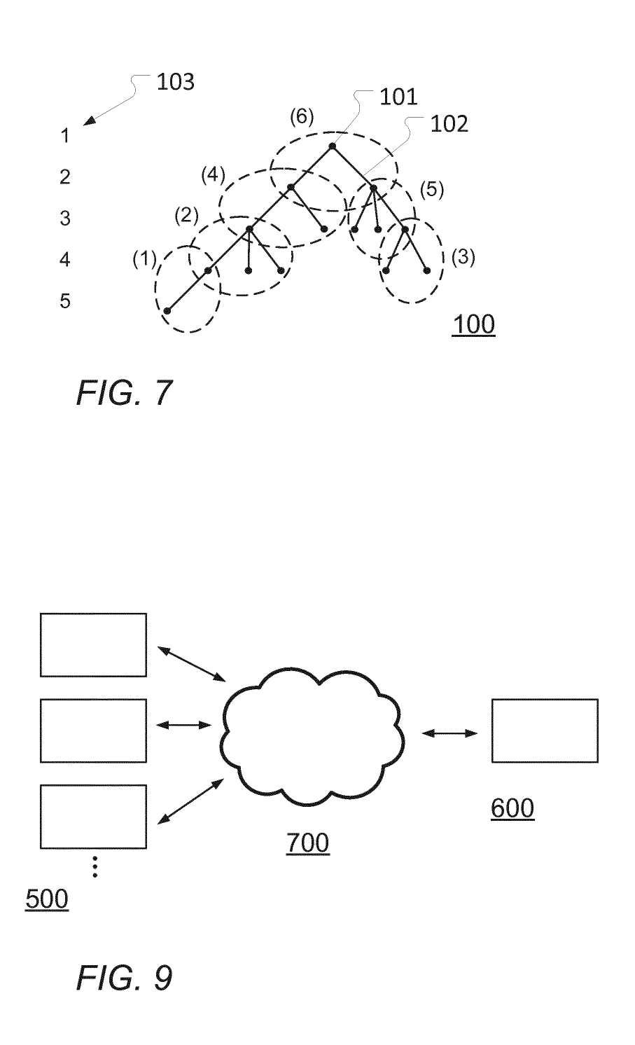

One execution of step 402 corresponds to one hatched circle in FIG. 7 as will be explained later.

After the data processing has been carried out, the method proceeds to step 403 where it is checked whether further unprocessed data values exist or not for the LLUP. If yes, the method continues back to step 401 where a new or next data value (e.g. now y instead of x) is selected. If no, the method continues to step 404 ending this sub-routine and reverting back to step 305 of FIG. 3.

It is to be understood that alternatively, all data values, e.g. x, y, z, etc., may be processed in parallel in one step thereby not needing steps 401 and 403.

One simple example could be calculating a financial consolidated result of a group having an organizational structure (with three levels) as depicted in FIG. 2. Data processing would begin with the data values from the firstly selected LLUP x2, y2, . . . (as selected by step 303 of FIG. 3) and its leaf children, where data values x and y then could represent revenues and costs, respectively, thus deriving a financial result by calculating z2=(x2+x4+x5−y2−y4−y5) for the first LLUP, i.e. for the leftmost node at level 2. After processing step 404 ends this iteration and the method reverts back to step 304 and then step 303 again (having carried out step 305 in between), where the next LLUP x3, y3, . . . is selected and processed according to steps 401 and 402 of FIG. 4 deriving the financial result z3=(x3+x6−y3−y6) for the secondly selected LLUP and continuing the data processing until the last LLUP x1, y1, . . . is selected and calculating the overall financial result as z1=z2+z3+x1−y1.

In some embodiments, the respective result (z) is stored for each LLUP, whereby not only the financial result of the group is readily available but also the financial results of each individual company of the group.

In some embodiments, a cash-flow may be derived as disclosed herein.

It is not uncommon with different companies of a group operating in different currencies. That may e.g. be handled letting one of the data values indicate what currency is applicable for a given company and then using an appropriate exchange rate or average exchange rate for a given time period (that may also be stored as a data values or otherwise be provided) in the calculations.

FIGS. 5a and 5b schematically illustrate an order of processing nodes of an exemplary data structure by the flow charts of FIGS. 3 and/or 4 and embodiments thereof.

Shown in FIG. 5a is an exemplary hierarchical data structure 100 corresponding to the ones of FIGS. 1 and 2 (but with a different structure and/or data values).

Indicated in FIG. 5a is an order of processing where the order is indicated by numbers in parenthesises, i.e. (1) designates the LLUP node being processed first according to the flow chart of FIG. 3, (2) designates the LLUP node being processed second, and so on.

In the shown example, the leftmost (parent) node at level 4 is processed first, followed by the leftmost node at level 3, followed by the rightmost node at level 3, etc.

The nodes that is shown as being processed as (2) and (3) are equal candidates for an LLUP node, so the node designated as (3) in FIG. 5a could equally be processed as (2) and then with the node designated as (2) in FIG. 5a being processed as (3). The same—in this particular example—is the case for the nodes designated (4) and (5). The same result is obtained by the overall processing and the same amount of overall computational effort is needed by the two orderings.

Shown and explained in connection with FIG. 5b is an alternative ordering.

Shown in FIG. 5b is—as an example—the hierarchical data structure 100 of FIG. 5a but where the processing order is determined according to an alternative embodiment.

As can be seen the processing order is different than in FIG. 5a. However, the same end result as in FIG. 5a is still obtained. According to the ordering of FIG. 5b, one branch from the root node is processed at a time (the order of processing the branches does not matter as the processing of the branches do not influence each other except for the root node) where the nodes (from all the level(s) below the root node) of the currently selected branch is processed as described according to FIGS. 3 and/or 4 and/or embodiments thereof, i.e. within the currently selected branch, an LLUP node is determined, processed, and then designated as processed and repeating this until all nodes below the root node of the selected branch has been processed and then repeating this for a next branch until all branches have been processed. Once all branches have been processed, the root node is processed.

Other processing orderings may also be used in further alternative embodiments as long as it is ensured that child nodes (and their children and so on) are processed before relevant parent nodes.

FIGS. 6a and 6b schematically illustrate pre-processing of a data structure and/or the data according to some embodiments.

Shown in FIG. 6a is an exemplary hierarchical data structure 100 corresponding to the ones of FIGS. 1 and 2 (but with a different structure and/or data values).

In this particular example, the data structure 100 comprises eleven nodes connected by connections 102 as shown across five levels 103. The nodes are each associated with one data value for simplicity's sake where the data values are labelled x1, . . . , x11.

One node (the second leftmost node at level 4 having data value x8) is a child of two parent nodes at level 3 as indicated by dashed connections. The data values of the two parent nodes sharing the child, each further comprises a weight percentage (here 25% and 75% respectively; it is noted that the sum of the weights do not necessarily need to be 100%) that represent or signify the weight of the (dashed) connection to the shared child, i.e. the leftmost node (with data value with x4) is connected to the child (with data value x8) according to a 25% weight while the other node (with data value x5) is connected to the same child according to a 75% weight.

In some embodiments with the nodes representing sensors of a connected sensor system and the data values representing sensor values, the weight could signify a weight as applied to the value of another sensor in the sensor system. As an example, the data processing of the sensor value x4 is influenced by 25% of sensor value x8 while the data processing of the sensor value x5 is influenced by 75% of sensor value x8.

In some other embodiments with the nodes representing legal entities, companies, etc. and the data values representing financial figures (such as turnover, revenue, cash-flow, etc.), the weight could signify partial ownership between the legal entities, companies, etc. As an example, the financial figure x4 is added 25% of the financial figure x8 as the legal entity (node) with x4 owns 25% of the legal entity (node) with x8 while the financial figure x5 is added 75% of the financial figure x8 as the legal entity (node) with x5 owns 75% of the legal entity (node) with x8.

As will be explained in connection with FIG. 6b, according to some embodiments, the hierarchal data structure 100 is modified and/or re-arranged for situations of one or more children shared by a plurality of parents to facilitate enhanced processing, such as faster processing time, simpler processing/calculations, etc.

Shown in FIG. 6b is the data structure 100 of FIG. 6a after the data structure has been modified and/or re-arranged according to some embodiments, as will be explained further in the following.

As can be seen, the entire data sub-structure of the shared child—including the shared child has been duplicated with one copy being connected only to one of the parents of the earlier shared child and the other copy being connected only to the other of the parents of the earlier shared child. The data values of the shared child and the data values of its sub-structure are modified, where appropriate, by the relevant weight. In the example, the data values of the leftmost duplicated sub-structure are multiplied or assigned with the weight of 25% while the data values of the rightmost duplicated sub-structure is multiplied or assigned with the weight of 75%.

Such modification and/or re-arrangement will simplify the data-processing steps of the entire data structure 100 and it now can be processed according to the flow chart of FIG. 3 and embodiments thereof without requiring any modifications of the execution steps.

It should be noted, that not all data values associated with a given node need to be modified by the weight. In a case with nodes being associated with data values x, y, and z, it may e.g. only be the x's and the z's (of the relevant sub-structure) that is modified by the weight while the y's are not. Which data values that are modified and which are not will depend on use and/or implementation.

It should also be noted, that the modification and/or re-arrangement may also be done for shared children with no weights (corresponding to each shared connection being weighted by 100%) which then do not require any modification of the data values of the sub-structure but only the duplication of the sub-structure.

This enables data processing of the computer-implemented method and embodiments thereof to readily be able to handle hierarchical data structures comprising cyclical connections.

FIG. 7 schematically illustrates, as an example, what data values are processed at each step in the order of processing of FIG. 5a.

Shown in FIG. 7 is, as an example, the data structure 100 of FIG. 5a.

Further illustrated is a number of numbers in parenthesises, i.e. (1), (2), (3), etc. and a number of dashed circles, where each number is associated with a respective dashed circle. The numbers in parenthesises designate, like in FIG. 5a, an order of processing but whereas the numbers in parenthesises of FIG. 5a indicates the order of determined or selected LLUP then the order in FIG. 7 indicates what nodes are processed for each determined or selected LLUP. The dashed circles indicate, respectively, which nodes are processed as part of processing a particular determined or selected LLUP.

As can be seen in this particular example, firstly the data values of the node at level 5 (being a leaf) and the leftmost node at level 4 (being the firstly selected LLUP) are processed—as illustrated by the dashed circle labelled (1). As mentioned, the result of this data processing is saved for the firstly selected LLUP (see e.g. step 305 in FIG. 3) before continuing to the second processing iteration. Secondly, the data values of the previous LLUP (being the result of the first processing iteration; now stored or associated with the leftmost node at level 4/the firstly selected LLUP), the second and third leftmost nodes at level 4, and the secondly selected LLUP (being the leftmost node at level 3) are processed and the result of this data processing is saved for the secondly selected LLUP (being the leftmost node at level 3), and so on until the root node have been processed as a sixth data processing iteration and an end result is provided or may be derived (see e.g. step 306 in FIG. 3).

As mentioned earlier, in some embodiments, the ordering may be different, e.g. corresponding to the example of FIG. 5b.

FIGS. 8a-8g schematically illustrate an embodiment where the hierarchical data structure is reduced as data processing progresses.

Shown is an exemplary hierarchical data structure corresponding to the ones explained in connection with FIGS. 1 and 2 and, as an example, being equal to the data structure of FIGS. 5a, 5b, and 7.

Shown in FIG. 8a is a hierarchical data structure 100 where it is indicated—by (*)—what LLUP is to be processed as disclosed herein.

FIG. 8b schematically illustrates the hierarchical data structure 100 after the first iteration of data processing has been carried out—corresponding to iteration (1) in FIGS. 5a and 7—as well as the next LLUP to be processed as indicated by (*). As can be seen, the data structure 100 has been reduced compared to FIG. 8a since the result of the data processing has been saved for or associated with the firstly selected LLUP and the sub-tree of the firstly selected LLUP has been removed or deleted (with its data value(s) having been used for the processing of the firstly selected LLUP) as this is no longer needed for processing purposes. In this particular example, the node at level 5 has been removed or deleted and the maximum level or depth of the data structure is now only 4.

This will reduce the amount of memory needed to store the data structure 100 in an appropriate memory and/or storage. In some embodiments, the original data structure 100 is kept at a storage (for efficiency of re-runs, etc.) and is only reduced in the memory.

FIG. 8c schematically illustrates the hierarchical data structure 100 after the data processing has been carried out with the selected LLUP as indicated in FIG. 8b. As can be seen, the LLUP (the leftmost node at level 3) has been updated with the result and the three nodes (three leftmost nodes at level 4) have been removed.

Indicated by (*) is also the next LLUP to be processed.

FIG. 8d-8g schematically illustrates, respectively, the progression of the state of the hierarchical data structure 100 after data processing has been carried out with the respective selected LLUPs.

As can be seen, at the end the hierarchical data structure 100 is a single node (the root node) updated or associated with a result that is or can be processed to become the end result or final result.

In this way, the memory and/or storage requirements for the data structure are dynamically reduced as data processing progresses.

FIG. 9 schematically illustrates a number of client systems or devices communicating with a data processing device or system according to the present invention.

Shown is a data processing system or device 600 adapted to execute the computer-implemented method and embodiments thereof as disclosed herein, a communications network 700, such as the Internet, a cloud network, and/or other types of network(s), and/or combinations thereof, and one or more data sources 500. The one or more data sources 500 may e.g. be internal (to the device or system 600), external (as shown), and/or any combination thereof.

A block diagram of some embodiments of the data processing system or device 600 and/or the data source(s) 500 is shown and explained further in connection with FIG. 10.

Relevant data is obtained by the data processing system or device 600 from the one or more data sources 500 via the network(s) 700. When received or during reception, the data is organised in a hierarchical data structure 100 corresponding to the ones of FIGS. 1 and 2 according to one or more predetermined rules, in some embodiments, being dependent on the type or kind of data values and/or data processing to be carried out. Alternatively, the data processing system or device 600 receives the data being already organised in a hierarchical data structure 100.

After the data is organised according to a hierarchical data structure 100, the data may be processed according to various embodiments as disclosed herein.

The data processing—in full or in part—may also be processed by one or more other data processing systems or devices (not shown).

FIG. 10 schematically illustrates a functional block diagram of embodiments of an electronic data processing device or system implementing various embodiments of the method mentioned throughout the specification.

Shown is a representation of an electronic data processing system or device 600 comprising one or more processing units 802 connected via one or more communications and/or data buses 801 to an electronic memory and/or electronic storage 803, one or more signal transmitter and receiver communications elements 804 (e.g. one or more selected from the group consisting of cellular, Bluetooth, WiFi, etc. communications elements) for communicating via a computer network, the Internet, and/or the like (see e.g. 700 in FIG. 9), an optional display 808, and one or more optional (e.g. graphical and/or physical) user interface elements 807.

The electronic data processing device or system 600 can e.g. be a suitably programmed computational device, e.g. like a PC, laptop, computer, server, smart-phone, tablet, etc. and is specifically programmed to carry out or execute the computer-implemented method(s) and embodiments thereof as disclosed herein and variations thereof.

The shown block diagram may e.g. also represent one of one or more internal and/or external data sources (see e.g. 500 in FIG. 9).

Some preferred embodiments have been shown in the foregoing, but it should be stressed that the invention is not limited to these, but may be embodied in other ways as falling within the subject matter as defined in the accompanying claims.

In the claims when enumerating several features, some or all of these features may be embodied by one and the same element, component, item or the like. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, elements, steps or components but does not preclude the presence or addition of one or more other features, elements, steps, components, or groups thereof.

1. A computer-implemented method of processing data in a hierarchical data structure, the method comprising the steps of:
obtaining data organised according to a hierarchical data structure according to one or more predetermined rules, the hierarchical data structure representing or comprising a plurality of nodes and a number of connections between the nodes, wherein
each node is associated with at least two or more data values each being of a respective data type selected from one or more data types, and
the nodes are organised in the hierarchical data structure according to a number of levels with one node being at a first level and the other nodes being at respective lower levels,
I. selecting a lowest level currently un-processed node being connected by a respective connection to at least one lower level node, each of the at least one lower level node having no connections to further lower level nodes,
II. performing data processing of one or more of the data values of the selected lowest level currently un-processed node and the at least one lower level node connected to the selected lowest level currently un-processed node and associating a result of the data processing with one or more data values of the selected lowest level currently un-processed node, and
III. designating the selected lowest level currently un-processed node as processed after the data processing has been performed.

2. The computer-implemented method according to claim 1, wherein the method comprises
repeating steps I, II, and III until a desired number of nodes have been processed, wherein step I after a first execution comprises:
selecting a lowest level currently un-processed node being connected by a respective connection to at least one lower level node and/or one or more already processed nodes, each of the at least one lower level node, if any, having no connections to further lower level nodes, and step II after a first execution comprises:
performing data processing of one or more of the data values of the selected lowest level currently un-processed node, the at least one lower level node, and/or the one or more already processed nodes connected to the selected lowest level currently un-processed node and associating a result of the data processing with one or more data values of the selected lowest level currently un-processed node.

3. The computer-implemented method according to claim 1, wherein
one node is designated as a primary or root node,
the hierarchical data structure comprises or represent one primary node connected to at least another node by a connection, and
at least one of the nodes is a parent node of at least one other node and at least one of the nodes is a child node of at least one of the nodes.

4. The computer-implemented method according to claim 1, wherein the hierarchical data structure is tree data structure.

5. The computer-implemented method according to claim 1, wherein the computer-implemented method further comprises the step of organising received or provided data according to the hierarchical data structure based on the one or more predetermined rules.

6. The computer-implemented method according to claim 1, wherein the one or more predetermined rules specify that
any two given nodes in the hierarchical data structure are connected if data processing of data values of one of the two nodes is dependent on data values, and/or data processing thereof, of the other of the two nodes, where the node for which data processing of data values is dependent is arranged at an adjacent higher level than the node that the data processing of data values is dependent upon,
any given node associated with data values for which data processing is not dependent on data values, and/or data processing thereof, of one or more other nodes will
be connected to a higher level node in the hierarchical data structure when data processing of the data values of the higher level node is dependent on data processing of the data values of the any given node, and
have no connection to any lower level nodes,
one given node associated with data values for which data processing is dependent on data values, and/or data processing thereof, of one or more other nodes but where no other node is associated with data values for which data processing is dependent on data values, and/or data processing thereof, of the one given node is designated as a primary node.

7. The computer-implemented method according to claim 1, wherein
the hierarchical data structure comprises a particular node that is connected to at least two nodes each at an adjacent higher level than a level of the particular node and each of the at least two nodes being associated with a data value representing a weight of the connection to the particular node, and
wherein the method further comprises the step of
replacing the connections between the particular node and the connected at least two nodes with one connection for each of the at least two nodes with a copy of the particular node including any lower level nodes being connected to the particular node and applying the respective weight to the data values of the particular node and data values of any lower level nodes being connected to the particular node for each copy of the particular node.

8. The computer-implemented method according to claim 1, wherein the step of performing data processing of one or more of the data values of the selected lowest level currently un-processed node and the at least one lower level node connected to the selected lowest level currently un-processed node comprises
performing predetermined data processing of data values of the selected lowest level currently un-processed node and data values of the at least one lower level node connected to the selected lowest level currently un-processed node providing a processing result comprising one or more data values.

9. The computer-implemented method according to claim 2, wherein the step of performing data processing of one or more of the data values of the selected lowest level currently un-processed node, the at least one lower level node and/or one or more already processed nodes connected to the selected lowest level currently un-processed node comprises
performing predetermined data processing of data values of the selected lowest level currently un-processed node and data values of the at least one lower level node and/or one or more already processed nodes connected to the selected lowest level currently un-processed node providing a processing result comprising one or more data values.

10. The computer-implemented method according to claim 8, wherein the method further comprises replacing the data values the selected lowest level currently un-processed node with the processing result and deleting or removing the at least one lower level node connected to the selected lowest level currently un-processed node from the hierarchical data structure.

11. The computer-implemented method according to claim 1, wherein the hierarchical data structure comprises
data values for each node being associated with a first state or a first time, and
data values for each node being associated with a second state or a second time, where the first state or first time respectively is earlier than the second state or the second time,
wherein step II comprises
a) deriving, for each of the at least one node of the selected lowest level currently un-processed node, the at least one lower level node, and/or the one or more already processed nodes connected to the selected lowest level currently un-processed node, a difference between a data value being associated with the first state or first time and the data value being associated with the second state or second time resulting in a differential result value,
or
b) deriving, for each of the at least one node of the selected lowest level currently un-processed node, the at least one lower level node, and/or the one or more already processed nodes connected to the selected lowest level currently un-processed node, a difference between a first data value and a second data value, both data values being associated with the first state or first time, resulting in a first differential value and difference between a third data value and a fourth data value, both data values being associated with the second state or second time, resulting in a second differential value, and deriving a difference between the first and the second differential value resulting in a differential result value.

12. The computer-implemented method according to claim 11, wherein the hierarchical data structure is associated with a first overall data type for a number of data values of the plurality of nodes, and wherein the method further comprises converting, if needed according to a predetermined criterion, the differential result value into a data value of the first overall data type.

13. A computer system or device wherein the computer system or device is adapted to execute the method according to claim 1.

14. A non-transient computer-readable medium, having stored thereon, instructions that when executed by a computer system or device cause the computer system or device to perform the method according to claim 1.

15. The computer-implemented method according to claim 9, wherein the method further comprises replacing the data values the selected lowest level currently un-processed node with the processing result and deleting or removing the at least one lower level node connected to the selected lowest level currently un-processed node from the hierarchical data structure.
